(19) United States
(12) Patent Application Publication
(10) Pub. No.: US 2007/0129902 A1
(43) Pub. Date: Jun. 7, 2007

(54) ELECTRONIC MODULE MOUNTING MEANS

(76) Inventor: Richard ORBELL, Setauket, NY (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/462,252

(22) Filed: Aug. 3, 2006

Related U.S. Application Data
(60) Provisional application No. 60/706,176, filed on Aug. 5, 2005.
(60) Provisional application No. 60/709,348, filed on Aug. 18, 2005.

(51) Int. Cl. G01F 23/00; G08B 21/00

(52) U.S. Cl. 702/55; 340/618; 73/292

(57) ABSTRACT

A mount for coupling a device to a support structure in a vehicle, the vehicle including a fuel tank for storing fuel, includes a canister having at least one surface insertable into the fuel tank so as to contact the fuel, the canister being impervious to the fuel. A cartridge is removably insertable into the canister, the cartridge being in thermal communication with the at least one surface, wherein the cartridge includes the device.

### RELATED APPLICATION DATA

This application claims priority of U.S. Provisional Application No. 60/706,176 filed on Aug. 5, 2005, and U.S. Provisional Application No. 60/709,348 filed on Aug. 18, 2005, both of which are incorporated herein by reference in their entirety.

### FIELD OF THE INVENTION

The present invention relates generally to liquid sensing arrangements and, more specifically, to utilizing thermal energy stored in fuel to maintain a temperature of an area or device.

### BACKGROUND OF THE INVENTION

On aircraft composed of carbon fiber composite wings, the length of wiring to sensors in wing-mounted fuel tanks is kept as short as possible. This minimizes the threat of a lightning strike conducting a significant quantity of energy into the fuel tank.

To minimize wiring length in the fuel tanks, several fuel level sensors in one or more fuel tanks connect to a local data concentrator device. This device, which is sometimes referred to as a remote data acquisition unit (RDAU) or remote data concentrator (RDC) (hereinafter referred to as an electronics module), is usually mounted just outside of the fuel tank on a spar. The electronics module has a sealed connector that passes through the tank wall, making electrical connections to sensors inside the fuel tank. The electronics module includes active electronic devices (often including a microprocessor) that have temperature ratings typically extending down to about minus forty degrees Celsius.

During flight, the temperature on a wing spar can fall as low as minus seventy degrees Celsius, which is significantly lower than the rating of many electronic devices. When an electronics module, such as the RDAU, is mounted on a spar of an aircraft's wing and connected to sensors within the wing's fuel tank, the electronics module is subjected to the low temperatures encountered during flight (e.g., as low as minus seventy degrees Celsius).

One approach to addressing these low spar temperatures is to add a heating element to the electronics module. The addition of the heating element, however, adds cost and complexity to the electronics module. Another approach has been to test all vulnerable electronic components at the minimum operating temperature seen at the spar. Then, only those components that can satisfactorily operate at these temperatures are used in the electronics module. Often, however, only a very small number of components can pass the test, resulting in low yields and, thus, increased costs.

### SUMMARY OF THE INVENTION

The present invention provides a system, apparatus and method for maintaining an ambient temperature for a device located within a vehicle, in particular an aircraft. More specifically, thermal energy stored within the vehicle's fuel is utilized to maintain the ambient temperature within safe operating regions of the device.

According to one aspect of the invention, there is provided a mount for coupling a device to a support structure in a vehicle, the vehicle including a fuel tank for storing fuel. The mount device includes a canister having at least one surface exposed to an inner portion of the fuel tank, the canister being impervious to the fuel. A cartridge is located inside the canister, the cartridge being in thermal communication with the at least one surface, wherein the cartridge includes the device.

According to another aspect of the invention, there is provided a system for maintaining an ambient temperature of an area within an operational range of one or more devices located in the area. The system includes a fuel tank for storing fuel, and a heat exchanger operative to extract thermal energy from fuel stored in the fuel tank.

According to another aspect of the invention, there is provided a method of mounting a device in a vehicle so as to maintain an ambient temperature around the device within an operation range of the device. The method includes the steps of: placing at least one surface of a canister in fluid communication with the fuel, wherein said canister is impervious to said fuel; placing a cartridge inside the canister such that the cartridge is in thermal communication with the fuel; and placing the device inside the cartridge.

According to another aspect of the invention, there is provided a method of maintaining an ambient temperature for a device in a vehicle, including using thermal energy of fuel stored in the vehicle to heat or cool the device.

According to another aspect of the invention, there is provided a mount for maintaining an ambient temperature of an area within an operational range of one or more devices located in the area. The mount includes a receptacle (e.g., a container or the like) extending into an interior of a fuel tank and opening to an exterior of the fuel tank, a sealed connector for establishing a through connection from the interior of the fuel tank to the interior of the receptacle, and a cartridge assembly insertable into the receptacle.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

### BRIEF DESCRIPTION OF THE DRAWINGS

The forgoing and other embodiments of the invention are hereinafter discussed with reference to the drawings.

FIG. 1 is an exemplary aircraft showing the location of fuel tanks and fuel sensors.

FIGS. 2A and 2B are a front view and side view, respectively, of an exemplary canister of a mounting system in accordance with the invention.

FIG. 3 is a side view of an exemplary cartridge in accordance with the invention, wherein an exemplary electronics module is shown inside the cartridge.

FIG. 4 is a side view illustrating the canister, cartridge and electronics module mounted to a wing spar in accordance with the invention.

FIG. 5 is a schematic diagram illustrating an exemplary power source for the electronics module.

### DETAILED DESCRIPTION

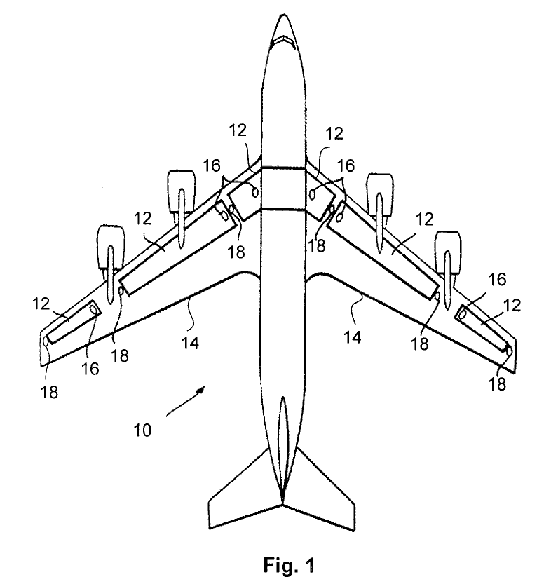

Referring initially to FIG. 1, an exemplary aircraft 10 includes a plurality of fuel tanks 12 mounted in wings 14 or other locations in the aircraft (not shown). Each fuel tank 12 includes one or more fuel sensors 16 for monitoring a fuel parameter, such as the fuel level or fuel temperature, for example. An electronics module 18 is mounted to a spar (not shown), and communicates to the fuel sensors 16 and other equipment. During flight, the wings 14 and spars within the wings 14 are exposed to extreme temperatures (e.g., about minus seventy degrees Celsius), which can be problematic for the fuel sensor's electronics module 18.

The present invention provides a system, apparatus and method for maintaining an ambient temperature for a device, such as the fuel sensor's electronics module 18, so as to shield or isolate the module 18 from the extreme temperatures encountered during flight or while on the ground. Moreover, active heating elements or special testing of the electronics module's components are not required (although such devices and/or techniques may be utilized within the scope of the invention). As described herein, thermal energy of fuel stored in the vehicle is used to maintain the ambient temperature for the device such that it is substantially the same as the fuel (e.g., within about five to ten degrees Celsius).

While the invention is described with respect to maintaining an ambient temperature for an electronics module, it will be appreciated that the invention may be used to maintain the ambient temperature for any device (electronic and non-electronic) or area. Further, while the invention is described in the context of an aircraft, it will be appreciated that it may be employed on any vehicle that utilizes relatively large fuel tanks, such as ships and locomotives, for example.

According to one aspect of the invention, a canister is in contact with the aircraft fuel and impervious to the fuel. The canister operates as a heat exchanger and utilizes the thermal energy stored in the fuel to maintain an ambient temperature within the canister. As will be appreciated, other types of heat exchangers may be used in place of the canister without departing from the scope of the invention (e.g., a shell and tube heat exchanger, a plate heat exchanger, etc.).

A cartridge is located within the canister, and the electronics module 18 is located in or on the cartridge. Both enclosures (i.e., the canister and cartridge) include sealed connectors that enable signals to enter and/or exit the respective enclosures while preventing fuel from entering the enclosures. By utilizing two enclosures, the thermal energy of the fuel can be easily used to maintain the temperature within both enclosures (and thus the electronics module 18), yet allow easy removal of the electronics module 18 without concern of fuel leakage or spillage.

As used herein, a canister is defined as a container, such as a box, can, cylinder, or the like. A cartridge is defined as a small modular unit designed to be inserted into a larger piece of equipment, such as a canister.

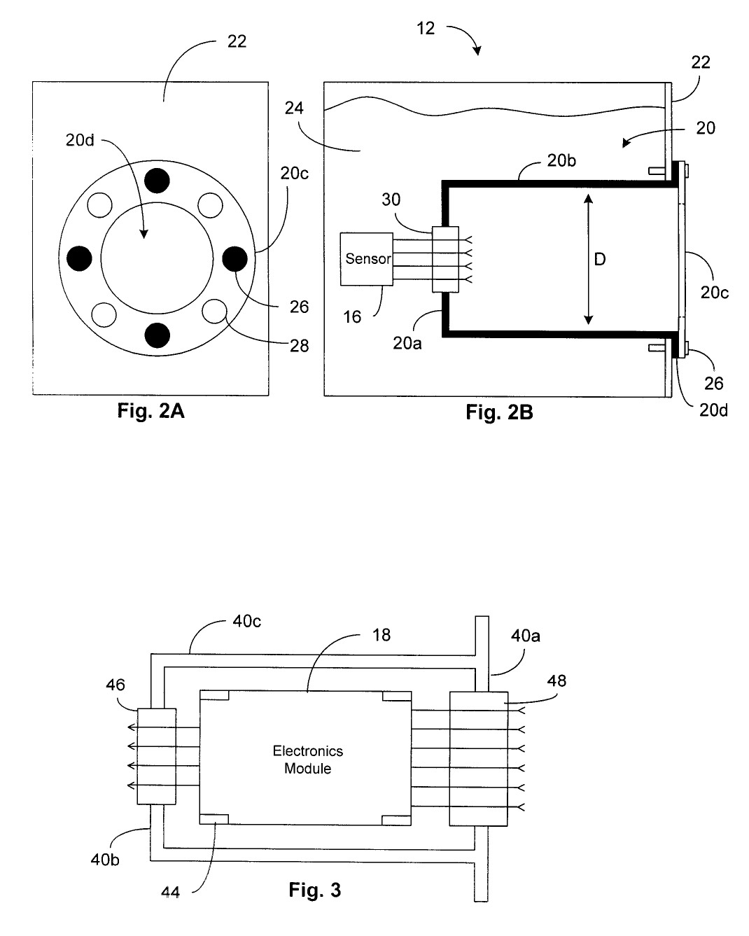

Referring now to FIGS. 2A and 2B, there is shown a front and side view of an exemplary canister 20 mounted to a wing spar 22 of aircraft 10. As is conventional, the wing spar 22 defines a portion of a fuel tank 12 for holding fuel 24. At least a portion of the canister 20 is in contact with the fuel 24. Preferably, the canister 20 is located near a lower portion of the tank 12 so as to maintain contact with the fuel 24 for as long as possible as the fuel is consumed. Although the canister 20 is shown as a separate unit from the fuel tank 12, the canister may be integrally formed with the fuel tank.

The canister 20 comprises a cylindrical container having a diameter D and defined by circular bottom wall 20a and cylindrical side wall 20b, which also holds the canister 20 to the spar 22. The canister includes a flange 20d for interfacing with the spar 22 and is secured to the spare via fasteners 26 (e.g., screws or the like). A cover 20c may be attached to the open end 20e of the canister. The canister 20 may be made out of any material that is impervious to the fuel. Preferably, the canister 20 is formed from a light-weight material, such as aluminum, for example. Additionally, an insulation means may be included between the canister 20 and the spar 22 for galvanic or other reasons.

The cover 20c includes an opening 20f that enables access into the canister 20. The flange 20d and/or cover 20f provide a means of accepting fasteners 28, which secure the cartridge 40 when mounted in the canister 20.

The bottom wall 20a includes a hermetically sealed connector 30, such as, for example, an electrical connector or fiber optic connector for communicating signals into and out of the canister 20. For example, electrical or optical signals from fuel sensor 16 located within the fuel tank 12 can be provided to the interior of the canister 20 through the connector 30, without fuel entering the canister 20.

Referring now to FIG. 3, there is shown an exemplary cartridge 40. The cartridge 40 is defined by circular top and bottom walls 40a and 40b, and cylindrical sidewall 40c. The cartridge 40 is dimensioned so as to fit within the canister 20. As will be appreciated, the cylindrical shape of the canister 20 and cartridge 40 is merely exemplary, and any shape may be utilized for the canister 20 and cartridge 40. For example, the canister 20 may have a cylindrical shape and the cartridge 40 may have a rectangular shape, so long as the cartridge 40 fits within the canister 20.

Located within the cartridge 40 is an electronics module 18. The electronics model 18 includes circuitry for performing conventional data acquisition and processing operations. For example, the electronics module 18 may include a number of integrated circuits, resistors, capacitors, etc. mounted on a printed circuit board and operative to exchange data between the fuel sensors 16 and a central controller (not shown) and/or to perform signal conditioning operations (e.g., signal filtering or the like). The electronics module 18 can be mounted to the top, bottom and/or sidewalls 40a, 40b or 40c of the cartridge 40 using one or more mounting members 44, such as fasteners and standoffs, for example.

It is noted that the cartridge 40 may take on may different forms. For example, and as described above, the cartridge 40 may be a container wherein the electronics module 18 is mounted inside or on cartridge. Alternatively, the cartridge 40 may be a film, coating, or the like surrounding and/or formed over the electronics module 18 (e.g., the electronics module may be encased in an epoxy resin, or a thin coating may be formed over the outer surface of the electronics module 18). In another embodiment, the device itself may be the cartridge.

The cartridge 40 also includes a first connector 46 and a second connector 48. The first and second connectors 46 and 48 preferably are hermetically sealed connectors. This is advantageous, for example, in that if the connector 30 of the canister fails (e.g., it leaks), the fuel 24 will not be able to enter the interior of the cartridge 40 and contact the electronics module 18. The first and second connectors 46 and 48 are couplable to the electronics module 18 so as to enable signals in/on the electronics module to be provided to other local or remote devices. For example, the first and second connectors 46 and 48 may be edge connectors that mate with corresponding edge portions of the electronics module's printed circuit board so as to provide an electrical connection to/from the electronics module 18. As will be appreciated, any type of connecting means that enables signals to be transferred to/from the electronics module 18 and the canister 20 and cartridge 40 may be used.

Further, the first connector 46 is couplable to the connector 30 of the canister 20, thereby enabling signals to be transmitted and received from devices external to the canister 20 and cartridge 40. For example, the connector 30 of the canister 20 may include a female receptacle (e.g., a fitting equipped to receive a plug or the like for facilitating an electrical connection), and the first connector 46 of the cartridge 40 may include a male plug that corresponds to the female receptacle. When the connectors 30 and 46 are coupled together, a connection (e.g. an electrical or optical connection) is made from the inside of the cartridge 40 to the outside of the canister 20 (e.g., from the electronics module 18 to the fuel sensors 16 located within the fuel tank 12).

The second connector 48 extends through the top wall 40c of the cartridge 40 and is coupled to a wiring harness or the like, which is couplable to the central controller. Via the second connector 48, signals may be transmitted to and/or received from devices located outside the canister 20 and cartridge 40. For example, data collected by the electronics module 18 may be communicated to an avionics control system (not shown) or the like. Similarly, data may be communicated from the avionics control system to the electronics module 18 and/or the fuel sensors 12. Such data may be in the form of feedback signals (e.g., actual fuel temperature, level, etc.) or command signals (e.g., alarm setpoints).

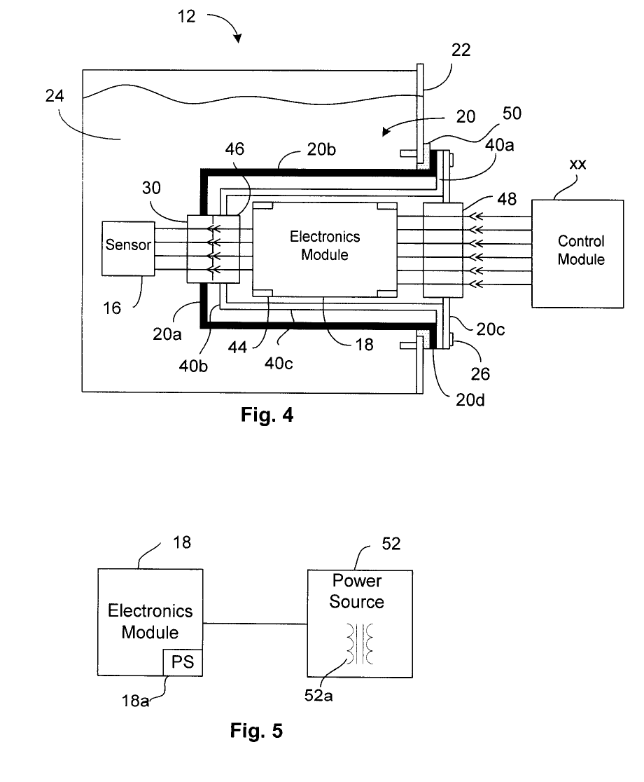

With further reference to FIG. 4, the electronics module 18 and cartridge 40 are shown mounted in the canister 20. As described above, the first connector 46 of the cartridge 40 mates with the connector 30 of the canister 20. This connection provides a communication path from the electronics module 18 (which is inside the cartridge 40) to the fuel sensors 16 (which are in the fuel tank 12 outside of the canister 20). The cartridge 40 may be removed from and inserted into the canister 20 via opening 20 within the flange 20d and cover 20c (if present).

As noted herein, the canister 20 is mounted near a bottom portion of the fuel tank 12 so as to immerse the canister 20 in fuel as long as possible. As the fuel is consumed, portions of the canister may become exposed and, as a result, the temperature of the canister 20 (and thus the cartridge 40 and electronics module 18) may approach that of the spar 22 and wing 14. To slow this process (and keep the electronics module 18 from becoming too cold too quickly) thermal insulation 50 can be placed between the canister 20 and the spar 22 as show in FIG. 4. Preferably, the thermal insulation 50 is electrically conductive so as provide protection against lighting strikes. Additionally, it is noted that if the canister 20 is mounted near a bottom portion of the fuel tank 12, exposure of the canister (if at all) occurs when the flight is nearly complete. Thus, the temperatures encountered by the exposed canister 20 will be substantially higher than minus 70 degrees Celsius.

As is known by those skilled in the art, lightning strikes can pose problems for aircraft electronics. To minimize the effects of lightning strikes, the electronics module 18 can be electrically isolated from the aircraft's frame ground, thereby providing enhanced protection against such strikes. For example, the electronics module 18 can be powered by an isolated power source. More specifically, and with reference to FIG. 5, a high frequency AC power source 52 can be used to power the electronics module 18. Preferably, the power source 52 operates on a frequency in the region of 10 KHz. The high frequency power source 52 is advantageous, for example, in that it allows the electronics module's power supply 18a to remain electrically isolated from other aircraft electronics. The electrical isolation can be accomplished, for example, using a small, lightweight ferrite transformer 52a in or near the power source 52. Additionally, by utilizing the high frequency power source 52, the power requirements of the electronics module 18 are simplified, thereby reducing the size and weight of the electronics module 18. The ferrite transformer 42a is designed to provide intrinsic safety, and forms part of the intrinsic safety barrier. Intrinsic safety of digital signals can be provided by optical isolation 52b. The electronics that interface with the in-tank sensors through connectors 46 and 30 are thus completely electrically isolated. Note that direct current power can be used, but additional circuitry would be required to provide the high frequency excitation for the ferrite transformer 52a.

Accordingly, an ambient temperature can be maintained for a device, such as an electronics module, using thermal energy stored in fuel. The thermal energy may be extracted via a mounting system that includes at least two enclosures, wherein one of the enclosures is in contact with the fuel and the other enclosure is in thermal communication with the fuel. As will be appreciated, other techniques of extracting the thermal energy from the fuel may be employed without departing from the scope of the invention.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A mount for coupling a device to a support structure in a vehicle, said vehicle including a fuel tank for storing fuel, comprising:
a canister including at least one surface exposed to an inner portion of the fuel tank, said canister being impervious to the fuel; and
a cartridge removably insertable into the canister, said cartridge in thermal communication with the at least one surface, wherein the cartridge includes the device.

2. The mount of claim 1, wherein the cartridge is at least one of a container, a resin encasing the device, or a film deposited over the device.

3. The mount of claim 1, wherein the canister includes a first connector couplable to a fuel sensor inside the fuel tank so as to enable signals to pass from the inside of the canister to the outside of the canister while preventing fuel from entering the inside of the canister.

4. The mount of claim 3, wherein the first electrical connector is a hermetically sealed connector.

5. The mount of claim 3, wherein the cartridge includes a second electrical connector coupled to the first connector and operable to exchange signals between the device and the fuel sensor.

6. The mount of claim 5, wherein the cartridge includes a third connector coupled to the device and couplable to external devices so as to enable transmission and reception of signals for control and/or monitoring of the fuel.

7. The mount of claim 1, further comprising a mounting member attachable to the support structure, said mounting member fixed to the canister.

8. The mount of claim 7, further comprising an insulation medium placed on the mounting member to thermally insulate the mounting member from the support structure.

9. The mount of claim 8, wherein the insulation is electrically conductive.

10. The mount of claim 1, wherein the cartridge is sealed so as to prevent fluids from entering or exiting an interior of the cartridge.

11. The mount of claim 1, wherein the device is electrically isolated from the vehicle's frame ground.

12. The mount of claim 1, wherein the device is an electronics module.

13. A system for maintaining an ambient temperature of an area within an operational range of one or more devices located in the area, comprising:
a fuel tank for storing fuel; and
a heat exchanger operative to extract thermal energy from fuel stored in the fuel tank.

14. The system of claim 13, wherein the heat exchanger comprises a canister located in the fuel tank such that the canister is at least partially immersed in the fuel.

15. The system of claim 14, further comprising a cartridge removably insertable into the canister, and wherein said area is at least partially within said cartridge.

16. The system of claim 14, wherein the canister is coupled to a bottom region of the fuel tank.

17. The system of claim 14, further comprising a high frequency power supply electrically coupled to the device.

18. The system of claim 17, wherein the high frequency power supply operates at a frequency of about 10 KHz,

19. The system of claim 17, wherein the power supply includes an isolation transformer.

20. A method of mounting a device in a vehicle so as to maintain an ambient temperature around the device within an operational range of the device, comprising:
placing at least one surface of a canister in fuel stored on the vehicle, wherein said canister is impervious to said fuel; and
placing cartridge assembly inside the canister such that the cartridge is in thermal communication with the fuel, said cartridge assembly including the device.

21. The method of claim 20, further comprising attaching the canister to a support structure.

22. The method of claim 21, further comprising insulating the canister from the support structure.

23. The method of claim 22, wherein insulating includes thermally insulating or galvanically insulating the canister from the support structure.

24. The method of claim 22, wherein insulating includes using electrically conductive insulation.

25. The method of claim 20, wherein placing at least one surface of the canister in the fuel includes locating the at least one surface in a lower region of a fuel tank.

26. A method of maintaining an ambient temperature of an area in or on a vehicle, comprising using thermal energy stored within fuel carried by the vehicle to heat or cool the area.

27. A mount for maintaining an ambient temperature of an area within an operational range of one or more devices located in the area, comprising:
a receptacle extending into an interior of a fuel tank and opening to an exterior of the fuel tank;
a sealed connector for establishing a through connection from the interior of the fuel tank to an interior of the receptacle; and
a cartridge assembly removably insertable into the receptacle.
